(19) United States
(12) Patent Application Publication
(10) Pub. No.: US 2016/0212980 A1
(43) Pub. Date: Jul. 28, 2016

(54) FISHING LINE MANAGEMENT SYSTEM

(71) Applicant: Sam E. Hodges, Leesburg, FL (US)

(72) Inventor: Sam E. Hodges, Leesburg, FL (US)

(21) Appl. No.: 14/603,806

(22) Filed: Jan. 23, 2015

(51) Int. Cl. A01K 87/04; A01K 87/02; A01K 91/00

(52) U.S. Cl. CPC A01K 87/04; A01K 91/00; A01K 87/025

(57) ABSTRACT

A fishing pole line management system that is functional, easy to use and durable. A line holder is used in combination with fishing line guides. With this invention it is possible to store extra fishing line, set fishing line to a fixed length, adjust fishing line length in and out and keep fishing line secure and in place during use or during storage. This invention allows for easy set up, hassle free use and easy take down of your fishing pole.

### RELATED APPLICATIONS

The present application is related to U.S. Pat. No. 2,608,015, issued Jan. 17, 2015, for FISHING POLE ATTACHMENT, by Alfred E. Peterson, included by reference herein.

The present application is related to U.S. Pat. No. 2,639,869, issued Jan. 17, 2015, for FISHLINE HOLDER, by Ira Levine, included by reference herein.

### FIELD OF THE INVENTION

The present invention relates to fishing pole line management and more particularly to a fishing pole line management system that aids in fishing line storage, adjustment and fishing line control while using and storing a fishing pole.

### BACKGROUND OF THE INVENTION

One object of the invention is to provide a simple lightweight device for holding and guiding fish line along the shaft of a fishing rod or pole and which may be attached to the body of a fishing rod or pole with the line holder component positioned toward the large butt end that is held by the fisherman and the line guide components are positioned along the fishing pole's shaft toward the fishing pole's tip and which enables the line to be taken in or paid out conveniently to provide an active or drop line of the length that may be required under different conditions. Often in fishing with a pole without a conventional reel, as from a boat or along a stream from shore, for example, a fisherman wishes to vary the length of his line due either to the depth of the water to the level to which he believes the fish may then be or other fishing conditions. Generally, a still fisherman, if using a pole without a conventional reel, has surplus line wound about the pole's tip and when a longer active line is desired, he must untie the line at the pole tip or release a half hitch, or the like, and unwind the line or wind it up, as the case may be, for adjusting the active line to the desired length. A device made in accordance with the present invention may be attached secured to the pole body for carrying the surplus line and allows for the active length or drop line to be taken in or paid out conveniently without tying or untying knots or half hitches in the line after each adjustment.

An additional object of the invention is to provide a device which is adapted to carry fishing line in a wound up form and which the device, with a line thereon, may quickly be attached to the body of a fish pole and which when so attached enables the line to be paid out or taken in under varying conditions at the will of the user generally by merely wrapping or unwrapping the line around the fishing pole line holder in one direction or the other. Also the line guides are used to guide and keep the fishing line in proper alignment to the fishing poles shaft similar to a fishing rod and reel setup. The use of this invention makes a fishing pole similar to a rod and reel without the line casting function.

Other more specific objectives and advantages of the invention will be apparent from the consideration of the following specification and accompanying drawings, wherein:

Consequently, other known fishing line holders and fishing pole attachments have been devised to ease related problems.

Examples of a known related but different devices are described in the following patent documents. U.S. Pat. No. 2,639,869, issued to Levine on May 26, 1953, described a fishing line holder attached to the end of a fishing pole that is related to improvements on fishing line holders, not a fishing line management system that utilizes a fishing line holder mounted in the proximity of the large butt end that is held by fisherman in combination with fishing line guides positioned along shaft from the fishing line holder to fishing pole end, similar to the configuration of a typical rod and reel setup. U.S. Pat. No. 2,608,015, issued to Peterson on Aug. 26, 1952, described a fishing pole attachment for attaching fishing tackle-assembly to the outer end of a fishing pole, not a fishing line management system that utilizes a fishing line holder mounted in the proximity of the large butt end of the fishing pole in combination with fishing line guides positioned along shaft in from the fishing line holder to fishing pole end.

None are known, however, to provide a simple, light weight, and convenient fishing line management advantages taught by this invention.

Although both the Fishing line holder U.S. Pat. No. 2,639,869, and Fishing pole attachment U.S. Pat. No. 2,608,015, provide fishing line storage and functionality of letting out and taking up fishing line, both are bulky and are mounted at the tip of the fishing pole, which poses a problem of having a bulky device mounted at the fishing pole tip where it is desirable for the pole in this area to be thin and flexible. This is not a good area for attaching bulky devices. Neither device offers mounting provisions for holding fishing line on the fishing pole's shaft in the proximity of the large butt end that is held by the fisherman as taught in this invention. Neither one offers similar component positioning as a typical rod and reel setup as taught in this invention. Neither one can deliver similar feel and user experience as taught in this invention.

### SUMMARY OF THE INVENTION

In accordance with the present invention, there is provided a fishing pole line management system that is functional, easy to use and durable. A line holder is used in combination with fishing line guides. With this invention it is possible to store extra fishing line, adjust fishing line length in and out of and keep fishing line secure and in place during use and during storage. This invention allows for easy set up, hassle free use and easy take down of your fishing pole.

It would be advantageous to provide a fishing pole line management system that provides an easy to use solution for storing extra fishing line for use on a fishing pole.

It would also be advantageous to provide a fishing pole line management system that provides an easy to use solution for adjusting the length of the fishing line in and out depending on fishing conditions.

It would also be advantageous to provide a fishing pole line management system that provides an easy to use solution to keep fishing line in the proper position while locating fish.

It would further be advantageous to provide a fishing pole line management system that provides an easy to use solution to keep fishing line in the proper position while catching fish.

It would also be advantageous to provide a fishing pole line management system that provides an easy to use solution for setting up a fishing pole for fishing.

It would further be advantageous to provide a fishing pole line management system that provides an easy to use solution for taking down your fishing pole for storage after fishing.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a top perspective view of an assembled fishing pole line management system;

FIG. 2 is a top perspective view of a fishing pole end cap;

FIG. 3 is a top perspective view of a line holder;

FIG. 4 is a top perspective view of a large line guide;

FIG. 5 is a top perspective view of an intermediate line guide;

FIG. 6 is a top perspective view of a small line guide;

FIG. 7 is a top perspective view of a fishing pole tip with hook;

FIG. 8 is a section view of an assembled fishing pole line management system;

FIG. 9 is a section view of a line holder;

FIG. 10 is a section view of a large line guide;

FIG. 11 is a section view of an intermediate line guide;

FIG. 12 is a section view of a small line guide;

FIG. 13 is a right view of an assembled fishing pole line management system;

FIG. 14 is a section view of a line holder;

FIG. 15 is a section view of a large line guide;

FIG. 16 is a section view of an intermediate line guide;

FIG. 17 is a section view of a small line guide;

FIG. 18 is a top perspective view of an alternate embodiment of the assembled fishing pole line management system;

FIG. 19 is a section view of an alternative embodiment of the line holder and shaft sizing shim material;

FIG. 20 is a section view of an alternative embodiment of the large line guide and shaft sizing shim material;

FIG. 21 is a section view of an alternative embodiment of the intermediate line guide and shaft sizing shim material; and

FIG. 22 is a section view of an alternative embodiment of the small line guide and shaft sizing shim material.

For purposes of clarity and brevity, like elements and components will bear the same designations and numbering throughout the Figures.

### DESCRIPTION OF THE PREFERRED EMBODIMENT

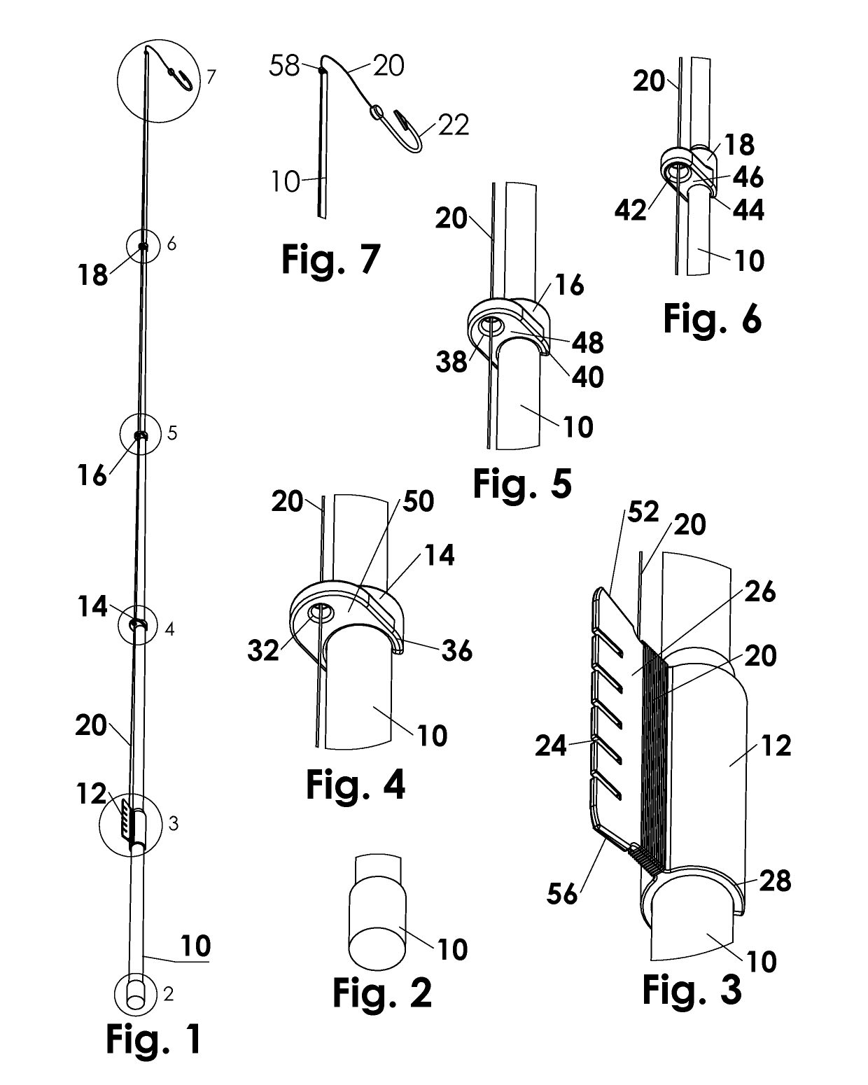

FIG. 1 is a top perspective view of an assembled fishing pole 10 line management system in accordance with the invention. The line holder 12 component, large line guide 14, intermediate line guide 16 and small line guide 18, are positioned and secured on the fishing pole 10 by snapping and sliding function of each component. Fishing line 20 for use on a fishing pole 10 is wrapped around the line holder vertical member 26 of the line holder 12 to provide secure storage for the fishing line 20 allowing the line length to be fixed, increased or shortened. The fishing line 20 is threaded through the large line guide 14 and then the intermediate line guide 16 and then the small line guide 18 and then the fishing pole end tip 58 and finally tied to a fishing hook 22. The collapsible type fishing pole 10 can be completely collapsed for storage. Using the snapping and sliding function of the large line guide 14, intermediate line guide 16, small line guide 18, as the sections of the collapsible pole are taken in the line is wrapped around the vertical wall of the line holder 12. The large line guide 14, intermediate line guide 16, small line guide 18 are slipped off of the fishing pole 10 but they remain on the fishing line 20. Using the line holder 12 hook/line securing slot 24 the fishing line 20, fishing hook 22, large line guide 14, intermediate line guide 16, small line guide 18 are held securely. The fishing pole 10 is of the collapsible type in the preferred embodiment. The collapsible type fishing pole 10 by design has a tapered shaft that allows the line holder clamping cylinder 28, large line guide clamping cylinder 36, intermediate line guide clamping cylinder 40, and small line guide clamping cylinder 44 to securely mount the line holder 12, large line guide 14, intermediate line guide 16 and small line guide 18 with a simple friction fit on the tapered shaft. In alternate embodiments, the alternative embodiment fishing pole 64 can be a bamboo cane pole or any other similar in shape pole. If the alternative embodiment fishing pole 64 shaft does not have the proper tapered shape or size then shaft sizing shim material 62 (hockey tape or similar material) can be wrapped around shaft of the alternative embodiment fishing pole 64 to provide thickness adjustment for a secure friction fit for the line holder 12 and the appropriate combination of large line guide 14, intermediate line guide 16 and small line guide 18. If a secure non-adjustable mounting solution is wanted the line holder 12, large line guide 14, intermediate line guide 16 and the small line guide 18 is securely attached with epoxy, glue, resin, or any other suitable material for a secure attachment.

FIG. 2 is a top perspective view of a fishing pole end cap 60 in accordance with the invention. The fishing pole end cap 60 is a component of the expandable type fishing pole 10.

FIG. 3 is a top perspective view of a line holder 12 in accordance with the invention. The line holder 12 component is attached to the fishing pole 10 by snapping the line holder clamping cylinder 28 around the fishing pole 10 and sliding the line holder 12 up the tapered shaft (small end to large end) of the fishing pole 10 for a secure tight attachment. Fishing line 20 is wrapped around the line holder vertical member 26 for storage and use while fishing. The line holder front line stop 52 and line holder back line stop 56 keeps the line from slipping off the top of the line holder 12 the hook/line securing slot 24 is used when you are preparing fishing pole 10 for travel or storage. One way to prepare the fishing pole 10 for storage is to position the hook in the hook/line securing slot 24 then the line coming from the fishing pole end tip 58 side is wrapped around the line holder vertical member 26 and at the same time that the line is taken up the collapsible sections are also taken up and the large line guide 14, intermediate line guide 16 and small line guide 18 are disconnected from the fishing pole 10 but stay connected to the fishing line 20. Take the large line guide 14, intermediate line guide 16 and small line guide 18 up to the line holder 12 then take the line in front of the small line guide 18 and loop it through the hook/line securing slot 24 and move line holder 12 away from fishing pole end tip 58. This adjusts the line tension for secure storage. Other ways to prepare the fishing pole 10 for storage are possible.

FIG. 4 is a top perspective view of a large line guide 14 in accordance with the invention. The large line guide 14 is attached to the fishing pole 10 by snapping the large line guide clamping cylinder 36 around the fishing pole 10 and sliding the large line guide 14 up the tapered shaft (small end to large end) of the fishing pole 10 for a secure tight attachment. The large line guide hole vertical tab 50 provides positioning for the large line guide line hole 32. The fishing line 20 is threaded through the large line guide line hole 32 to keep fishing line 20 close and parallel to the fishing pole 10 shaft.

FIG. 5 is a top perspective view of an intermediate line guide 16 in accordance with the invention. The intermediate line guide 16 is attached to the fishing pole 10 by snapping the intermediate line guide clamping cylinder 40 around the fishing pole 10 and sliding the intermediate line guide 16 up the tapered shaft (small end to large end) of the fishing pole 10 for a secure tight attachment. The intermediate line guide hole vertical tab 48 provides positioning for the intermediate line guide line hole 38. The fishing line 20 is threaded through the intermediate line guide line hole 38 to keep fishing line 20 close and parallel to the fishing pole 10 shaft.

FIG. 6 is a top perspective view of a small line guide 18 in accordance with the invention. The small line guide 18 is attached to the fishing pole 10 by snapping the small line guide clamping cylinder 44 around the fishing pole 10 and sliding the small line guide 18 up the tapered shaft (small end to large end) of the fishing pole 10 for a secure tight attachment. The small line guide hole vertical tab 46 provides positioning for the small line guide line hole 42. The fishing line 20 is threaded through the small line guide line hole 42 to keep fishing line 20 close and parallel to the fishing pole 10 shaft.

FIG. 7 is a top perspective view of a fishing pole end tip 58 with hook in accordance with the invention. The fishing pole end tip 58 is a component of the expandable type fishing pole 10. The line is threaded through the fishing pole end tip 58 and tied to a hook. If alternative embodiment fishing pole 64 is used the alternative embodiment fishing pole 64 will not have its own fishing pole end tip 58. The fishing pole's small end should be trimmed to 0.125″ diameter and the small line guide 18 should be fitted at the end of the alternative embodiment fishing pole 64 using shaft sizing material (hockey tape or similar material) for proper alternative embodiment fishing pole 64 shaft sizing.

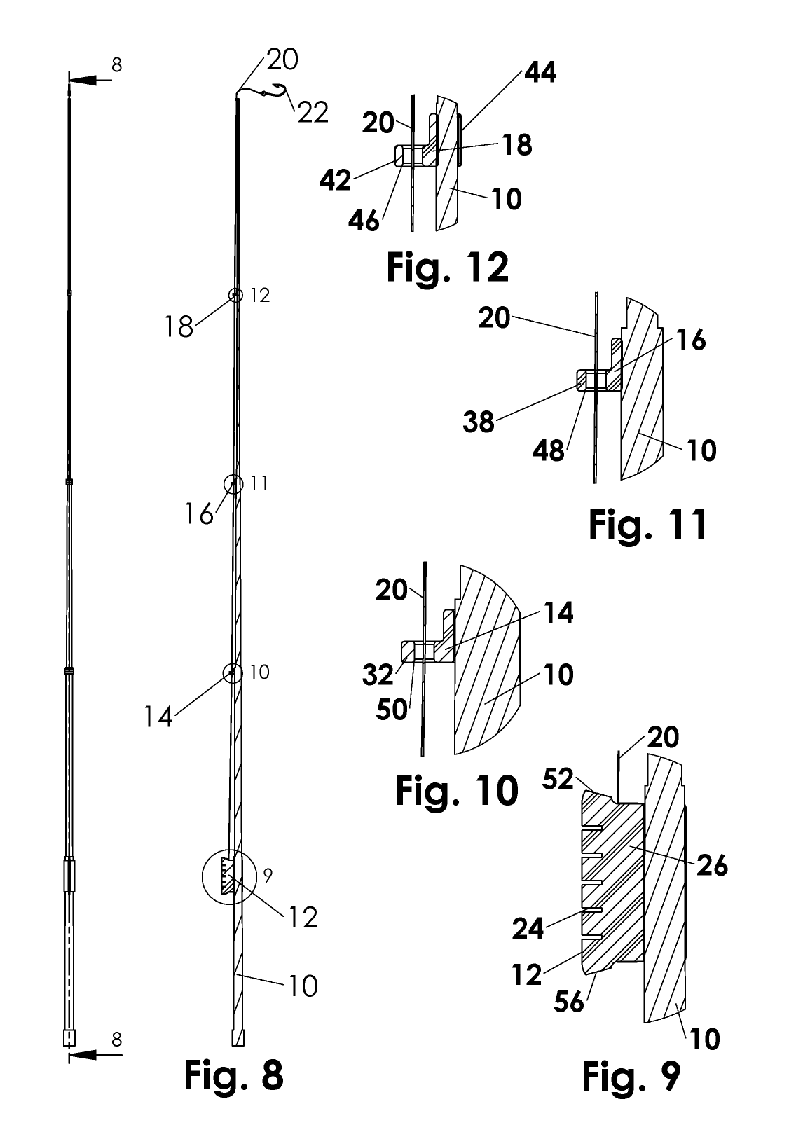

FIG. 8 is a section view of an assembled fishing pole 10 line management system in accordance with the invention. The line holder 12 component, large line guide 14, intermediate line guide 16 and small line guide 18, are positioned and secured on the fishing pole 10 by snapping and sliding function of each component. Fishing line 20 for use on a fishing pole 10 is wrapped around the line holder vertical member 26 of the line holder 12 to provide secure storage for the fishing line 20 allowing the line length to be fixed, increased or shortened. The fishing line 20 is the threaded through the large line guide 14 and then the intermediate line guide 16 and then the small line guide 18 and then the fishing pole end tip 58 and finally tied to a fishing hook 22. The collapsible type fishing pole 10 can be completely collapsed for storage. Using the snapping and sliding function of the large line guide 14, intermediate line guide 16, small line guide 18, as the sections of the collapsible pole are taken in, the line is wrapped around the vertical wall of the line holder 12. The large line guide 14, intermediate line guide 16, small line guide 18 are slipped off of the fishing pole 10 but they remain on the fishing line 20. Using the line holder 12 hook/line securing slot 24 the fishing line 20, fishing hook 22, large line guide 14, intermediate line guide 16, small line guide 18 are held securely. The fishing pole 10 is of the collapsible type in the preferred embodiment. The collapsible type fishing pole 10 by design has a tapered shaft that allows the line holder clamping cylinder 28, large line guide clamping cylinder 36, intermediate line guide clamping cylinder 40, and small line guide clamping cylinder 44 to securely mount the line holder 12, large line guide 14, intermediate line guide 16 and small line guide 18 with a simple friction fit on the tapered shaft. In alternate embodiments, the alternative embodiment fishing pole 64 can be a bamboo cane pole or any other similar in shape pole. If the alternative embodiment fishing pole 64 shaft does not have the proper tapered shape or size then shaft sizing shim material 62 (hockey tape or similar material) can be wrapped around shaft of the alternative embodiment fishing pole 64 to provide thickness adjustment for a secure friction fit for the line holder 12 and the appropriate combination of large line guide 14, intermediate line guide 16 and small line guide 18. If a secured non-adjustable mounting solution is wanted the line holder 12, large line guide 14, intermediate line guide 16 and the small line guide 18 is securely attached with epoxy, glue, resin, or any other suitable material for a secure attachment.

FIG. 9 is a section view of a line holder 12 in accordance with the invention. The line holder 12 component is attached to the fishing pole 10 by snapping the line holder clamping cylinder 28 around the fishing pole 10 and sliding the line holder 12 up the tapered shaft (small end to large end) of the fishing pole 10 for a secure tight attachment. Fishing line 20 is wrapped around the line holder vertical member 26 for storage and use while fishing. The line holder front line stop 52 and line holder back line stop 56 keeps the line from slipping off the top of the line holder 12 the hook/line securing slot 24 is used when you are preparing fishing pole 10 for travel or storage. One way to prepare the fishing pole 10 for storage is to position the hook in the hook/line securing slot 24 then the line coming from the fishing pole end tip 58 side is wrapped around the line holder vertical member 26 and at the same time that the line is taken up the collapsible sections are also taken up and the large line guide 14, intermediate line guide 16 and small line guide 18 are disconnected from the fishing pole 10 but stay connected to the fishing line 20. Take the large line guide 14, intermediate line guide 16 and small line guide 18 up to the line holder 12 then take the line in front of the small line guide 18 and loop it through the hook/line securing slot 24 and move line holder 12 away from fishing pole end tip 58. This adjusts the line tension for secure storage. Other ways to prepare the fishing pole 10 for storage are possible.

FIG. 10 is a section view of a large line guide 14 in accordance with the invention. The large line guide 14 is attached to the fishing pole 10 by snapping the large line guide clamping cylinder 36 around the fishing pole 10 and sliding the large line guide 14 up the tapered shaft (small end to large end) of the fishing pole 10 for a secure tight attachment. The large line guide hole vertical tab 50 provides positioning for the large line guide line hole 32. The fishing line 20 is threaded through the large line guide line hole 32 to keep fishing line 20 close and parallel to the fishing pole 10 shaft.

FIG. 11 is a section view of an intermediate line guide 16 in accordance with the invention. The intermediate line guide 16 is attached to the fishing pole 10 by snapping the intermediate line guide clamping cylinder 40 around the fishing pole 10 and sliding the intermediate line guide 16 up the tapered shaft (small end to large end) of the fishing pole 10 for a secure tight attachment. The intermediate line guide hole vertical tab 48 provides positioning for the intermediate line guide line hole 38. The fishing line 20 is threaded through the intermediate line guide line hole 38 to keep fishing line 20 close and parallel to the fishing pole 10 shaft.

FIG. 12 is a section view of a small line guide 18 in accordance with the invention. The small line guide 18 is attached to the fishing pole 10 by snapping the small line guide clamping cylinder 44 around the fishing pole 10 and sliding the small line guide 18 up the tapered shaft (small end to large end) of the fishing pole 10 for a secure tight attachment. The small line guide hole vertical tab 46 provides positioning for the small line guide line hole 42. The fishing line 20 is threaded through the small line guide line hole 42 to keep fishing line 20 close and parallel to the fishing pole 10 shaft.

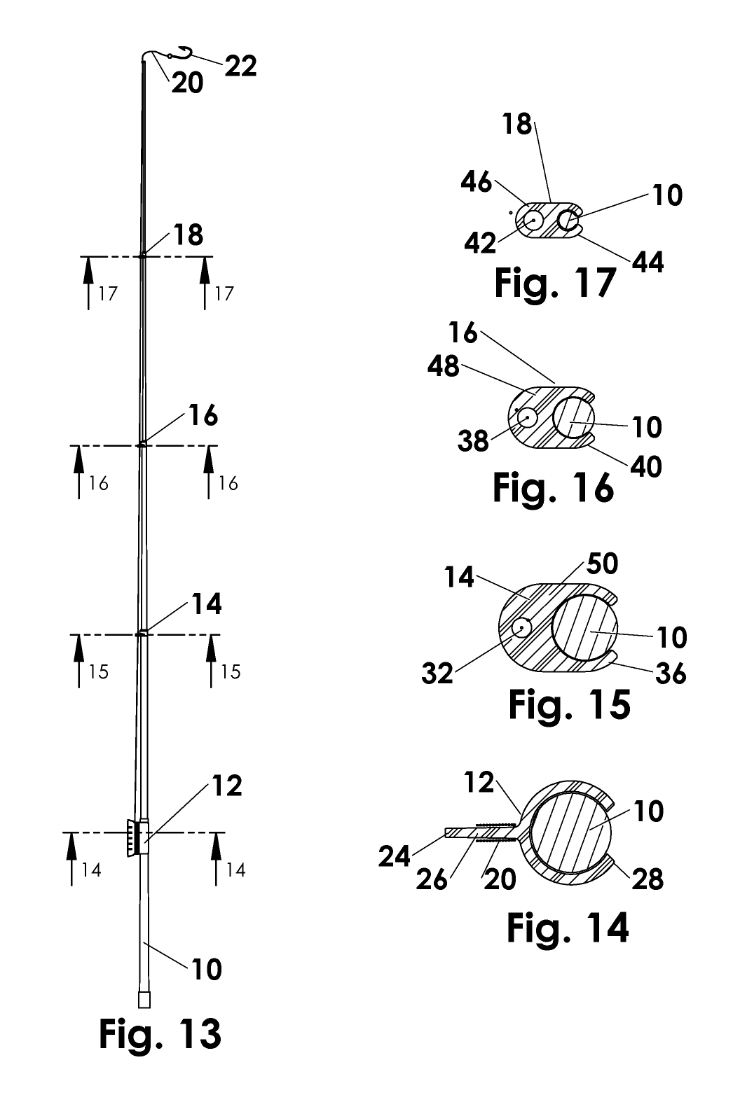

FIG. 13 is a right view of an assembled fishing pole 10 line management system in accordance with the invention. The line holder 12 component, large line guide 14, intermediate line guide 16 and small line guide 18, are positioned and secured on the fishing pole 10 by snapping and sliding function of each component. Fishing line 20 for use on a fishing pole 10 is wrapped around the line holder vertical member 26 of the line holder 12 to provide secure storage for the fishing line 20 allowing the line length to be fixed, increased or shortened. The fishing line 20 is the threaded through the large line guide 14 and then the intermediate line guide 16 and then the small line guide 18 and then the fishing pole end tip 58 and finally tied to a fishing hook 22. The collapsible type fishing pole 10 can be completely collapsed for storage. Using the snapping and sliding function of the large line guide 14, intermediate line guide 16, small line guide 18, as the sections of the collapsible pole are taken in the line is wrapped around the vertical wall of the line holder 12. The large line guide 14, intermediate line guide 16, small line guide 18 are slipped off of the fishing pole 10 but they remain on the fishing line 20. Using the line holder 12 hook/line securing slot 24 the fishing line 20, fishing hook 22, large line guide 14, intermediate line guide 16, small line guide 18 are held securely. The fishing pole 10 is of the collapsible type in the preferred embodiment. The collapsible type fishing pole 10 by design has a tapered shaft that allows the line holder clamping cylinder 28, large line guide clamping cylinder 36, intermediate line guide clamping cylinder 40, and small line guide clamping cylinder 44 to securely mount the line holder 12, large line guide 14, intermediate line guide 16 and small line guide 18 with a simple friction fit on the tapered shaft. In alternate embodiments, the alternative embodiment fishing pole 64 can be a bamboo cane pole or any other similar in shape pole. If the alternative embodiment fishing pole 64 shaft does not have the proper tapered shape or size then shaft sizing shim material 62 (hockey tape or similar material) can be wrapped around shaft of the alternative embodiment fishing pole 64 to provide thickness adjustment for a secure friction fit for the line holder 12 and the appropriate combination of large line guide 14, intermediate line guide 16 and small line guide 18. If a secure non-adjustable mounting solution is wanted the line holder 12, large line guide 14, intermediate line guide 16 and the small line guide 18 is securely attached with epoxy, glue, resin, or any other suitable material for a secured attachment.

FIG. 14 is a section view of a line holder 12 in accordance with the invention. The line holder 12 component is attached to the fishing pole 10 by snapping the line holder clamping cylinder 28 around the fishing pole 10 and sliding the line holder 12 up the tapered shaft (small end to large end) of the fishing pole 10 for a secure tight attachment. Fishing line 20 is wrapped around the line holder vertical member 26 for storage and use while fishing. The line holder front line stop 52 and line holder back line stop 56 keeps the line from slipping off the top of the line holder 12 the hook/line securing slot 24 is used when you are preparing fishing pole 10 for travel or storage. One way to prepare the fishing pole 10 for storage is to position the hook in the hook/line securing slot 24 then the line coming from the fishing pole end tip 58 side is wrapped around the line holder vertical member 26 and at the same time that the line is taken up the collapsible sections are also taken up and the large line guide 14, intermediate line guide 16 and small line guide 18 are disconnected from the fishing pole 10 but stay connected to the fishing line 20. Take the large line guide 14, intermediate line guide 16 and small line guide 18 up to the line holder 12 then take the line in front of the small line guide 18 and loop it through the hook/line securing slot 24 and move line holder 12 away from fishing pole end tip 58. This adjusts the line tension for secure storage. Other ways to prepare the fishing pole 10 for storage are possible.

FIG. 15 is a section view of a large line guide 14 in accordance with the invention. The large line guide 14 is attached to the fishing pole 10 by snapping the large line guide clamping cylinder 36 around the fishing pole 10 and sliding the large line guide 14 up the tapered shaft (small end to large end) of the fishing pole 10 for a secure tight attachment. The large line guide hole vertical tab 50 provides positioning for the large line guide line hole 32. The fishing line 20 is threaded through the large line guide line hole 32 to keep fishing line 20 close and parallel to the fishing pole 10 shaft.

FIG. 16 is a section view of an intermediate line guide 16 in accordance with the invention. The intermediate line guide 16 is attached to the fishing pole 10 by snapping the intermediate line guide clamping cylinder 40 around the fishing pole 10 and sliding the intermediate line guide 16 up the tapered shaft (small end to large end) of the fishing pole 10 for a secure tight attachment. The intermediate line guide hole vertical tab 48 provides positioning for the intermediate line guide line hole 38. The fishing line 20 is threaded through the intermediate line guide line hole 38 to keep fishing line 20 close and parallel to the fishing pole 10 shaft.

FIG. 17 is a section view of a small line guide 18 in accordance with the invention. The small line guide 18 is attached to the fishing pole 10 by snapping the small line guide clamping cylinder 44 around the fishing pole 10 and sliding the small line guide 18 up the tapered shaft (small end to large end) of the fishing pole 10 for a secure tight attachment. The small line guide hole vertical tab 46 provides positioning for the small line guide line hole 42. The fishing line 20 is threaded through the small line guide line hole 42 to keep fishing line 20 close and parallel to the fishing pole 10 shaft.

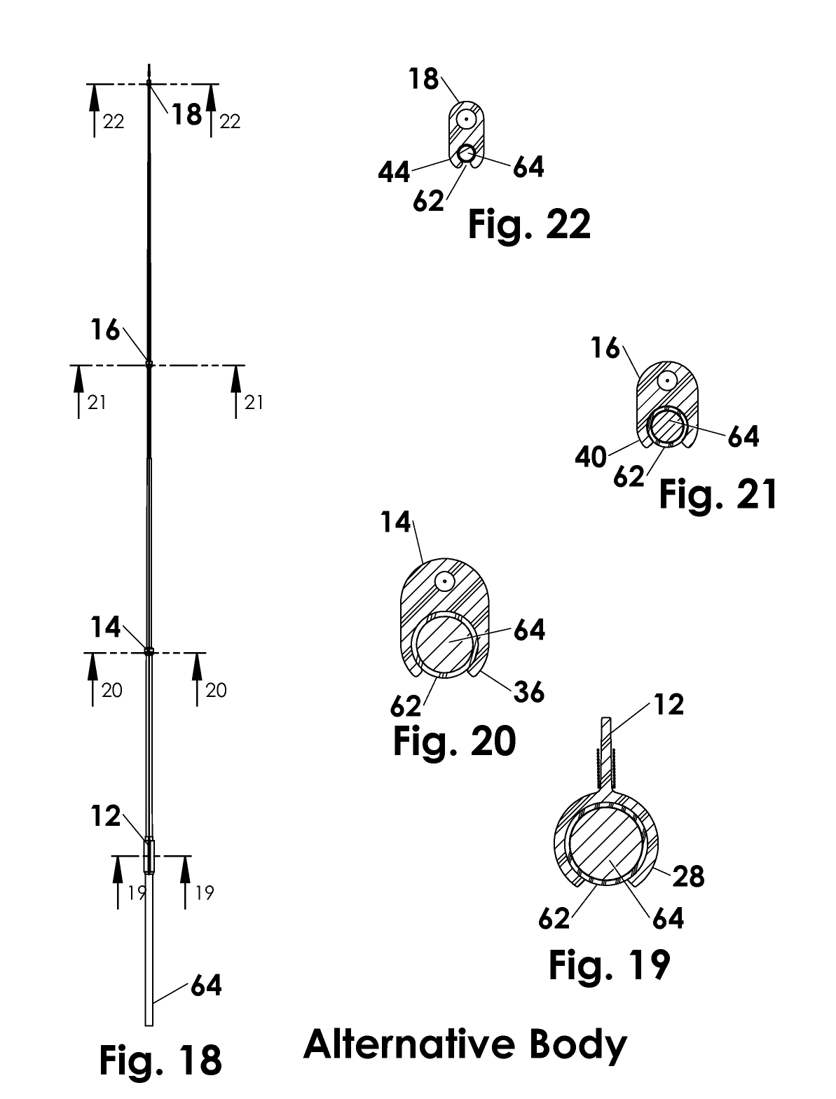

FIG. 18 which is a top perspective view of an assembled alternative embodiment fishing pole 64 line management system in accordance with the invention. The line holder 12 component, large line guide 14, intermediate line guide 16 and small line guide 18, are positioned and secured on the fishing pole 10 by snapping and sliding function of each component. Fishing line 20 for use on an alternative embodiment fishing pole 64 is wrapped around the line holder vertical member 26 of the line holder 12 to provide secure storage for the fishing line 20 allowing the line length to be let out for fishing or taken in for storage position. If the alternative embodiment fishing pole 64 does not have a pre-installed fishing pole end tip 58 then the small line guide 18 will become the end tip and the alternative embodiment fishing pole 64 should be trimmed at 0.125 diameter and shaft sizing shim material 62 (hockey tape or similar material) should be used to size the shaft to securely fit the small line guide 18. The fishing line 20 is then threaded through the large line guide 14 and then the intermediate line guide 16 and then the small line guide 18 and then finally tied to a fishing hook 22. The collapsible type fishing pole 10 in the preferred embodiment. The collapsible type fishing pole 10 by design has a tapered shaft that allows the line holder clamping cylinder 28, large line guide clamping cylinder 36, intermediate line guide clamping cylinder 40, and small line guide clamping cylinder 44 to securely mount the line holder 12, large line guide 14, intermediate line guide 16 and small line guide 18 with a simple friction fit on the tapered shaft. The alternative embodiment fishing pole 64 can be a bamboo cane pole or any other similar in shape pole. If the alternative embodiment fishing pole 64 shaft does not have the proper tapered shape or sized shaft then shaft sizing shim material 62 (hockey tape or similar material) is wrapped around shaft of the alternative embodiment fishing pole 64 to provide thickness adjustment for proper secure friction fit for the line holder 12 and the appropriate combination of large line guide 14, intermediate line guide 16 and small line guide 18. If a secure non-adjustable mounting solution is wanted the line holder 12, large line guide 14, intermediate line guide 16 and the small line guide 18 is securely attached with epoxy, glue, resin, or any other suitable material for a secured attachment. With a the non collapsing alternative embodiment fishing pole 64 configuration one would simply wrap the line hook end around the line holder vertical member 26 and place the hook in the hook/line securing slot 24 on the line holder 12 for storage.

FIG. 19 which is a section view of the alternative embodiment of the line holder 12 in accordance with the invention. The line holder 12 component is attached to the alternative embodiment fishing pole 64 by snapping the line holder clamping cylinder 28 around the alternative embodiment fishing pole 64 and sliding the line holder 12 up the tapered shaft (small end to large end) of the alternative embodiment fishing pole 64 for a secure tight attachment. If the alternative embodiment fishing pole 64 shaft does not have the proper tapered shape or sized shaft then shaft sizing shim material 62 (hockey tape or similar material) can be wrapped around shaft of the alternative embodiment fishing pole 64 to provide thickness adjustment for proper secure friction fit for the line holder 12. The desired amount of fishing line 20 is wrapped around the line holder vertical member 26 for storage and use while fishing. The line holder front line stop 52 and line holder back line stop 56 keeps the line from slipping off the top of the line holder 12 the hook/line securing slot 24 is used when you are preparing the alternative embodiment fishing pole 64 for travel or storage, the hook is positioned in the hook/line securing slot 24 then wrap the fishing line 20 around the line holder vertical member 26 to take out all of the slack.

FIG. 20 which is a section view of the alternative embodiment of the large line guide 14 in accordance with the invention. The large line guide 14 is attached to the alternative embodiment fishing pole 64 by snapping the large line guide clamping cylinder 36 around the fishing pole 10 and sliding the large line guide 14 up the tapered shaft (small end to large end) of the alternative embodiment fishing pole 64 for a secure tight attachment. If the alternative embodiment fishing pole 64 shaft does not have the proper tapered shape or sized shaft then shaft sizing shim material 62 (hockey tape or similar material) can be wrapped around shaft of the alternative embodiment fishing pole 64 to provide thickness adjustment for proper secure friction fit for the large line guide 14. The large line guide hole vertical tab 50 provides positioning for the large line guide line hole 32. The fishing line 20 is threaded through the large line guide line hole 32 to keep fishing line 20 close and parallel to the alternative embodiment fishing pole 64 shaft.

FIG. 21 which is a section view of the alternative embodiment of the intermediate line guide 16 in accordance with the invention. The intermediate line guide 16 is attached to the alternative embodiment fishing pole 64 by snapping the intermediate line guide clamping cylinder 40 around the alternative embodiment fishing pole 64 and sliding the intermediate line guide 16 up the tapered shaft (small end to large end) of the alternative embodiment fishing pole 64 for a secure tight attachment. If the alternative embodiment fishing pole 64 shaft does not have the proper tapered shape or sized shaft then shaft sizing shim material 62 (hockey tape or similar material) can be wrapped around shaft of the alternative embodiment fishing pole 64 to provide thickness adjustment for proper secure friction fit for the intermediate line guide 16. The intermediate line guide hole vertical tab 48 provides positioning for the intermediate line guide line hole 38. The fishing line 20 is threaded through the intermediate line guide line hole 38 to keep fishing line 20 close and parallel to the alternative embodiment fishing pole 64 shaft.

FIG. 22 which is a section view of the alternative embodiment of the small line guide 18 in accordance with the invention. The small line guide 18 is attached to the alternative embodiment fishing pole 64 by snapping the small line guide clamping cylinder 44 around the alternative embodiment fishing pole 64 and sliding the small line guide 18 up the tapered shaft (small end to large end) of the alternative embodiment fishing pole 64 for a secure tight attachment. If the alternative embodiment fishing pole 64 shaft does not have the proper tapered shape or sized shaft then shaft sizing shim material 62 (hockey tape or similar material) can be wrapped around shaft of the alternative embodiment fishing pole 64 to provide thickness adjustment for proper secure friction fit for the small line guide 18. The small line guide hole vertical tab 46 provides positioning for the small line guide line hole 42. The fishing line 20 is threaded through the small line guide line hole 42 to keep fishing line 20 close and parallel to the alternative embodiment fishing pole 64 shaft.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A fishing pole line management system for holding, securing and adjusting fishing pole line length, comprising:
means for line holding, line adjusting, line securing, hook securing;
means for keeping the fishing line parallel and close to the fishing pole shaft and providing fishing line guidance at the large line guide position;
means for keeping the fishing line parallel and close to the fishing pole shaft and providing fishing line guidance at the intermediate line guide position;
means for keeping the fishing line parallel and close to the fishing pole shaft and providing fishing line guidance at the small line guide position;
means for securing hook and line while fishing and not fishing;
means for positioning line and holding line in a secure fashion, permanently connected to said means for line holding, line adjusting, line securing, hook securing;
means for keeping fishing line in place at the front of the line holder, permanently connected to said means for line holding, line adjusting, line securing, hook securing;
means for keeping fishing line in place at the back of the line holder, permanently connected to said means for line holding, line adjusting, line securing, hook securing;
means for providing dependable secure easy mounting and removal for the line holder component, permanently connected to said means for line holding, line adjusting, line securing, hook securing;
means for providing vertical structure for large line guide hole, permanently connected to said means for keeping the fishing line parallel and close to the fishing pole shaft and providing fishing line guidance at the large line guide position;
means for providing line positioning control at the large line guide position, permanently connected to said means for keeping the fishing line parallel and close to the fishing pole shaft and providing fishing line guidance at the large line guide position;
means for providing dependable secure easy mounting and removal for the large line guide component, permanently connected to said means for keeping the fishing line parallel and close to the fishing pole shaft and providing fishing line guidance at the large line guide position;
means for providing vertical structure for intermediate line guide hole, permanently connected to said means for keeping the fishing line parallel and close to the fishing pole shaft and providing fishing line guidance at the intermediate line guide position;
means for providing line positioning control at the intermediate line guide position, permanently connected to said means for keeping the fishing line parallel and close to the fishing pole shaft and providing fishing line guidance at the intermediate line guide position;
means for providing dependable secure easy mounting and removal for the intermediate line guide component, permanently connected to said means for keeping the fishing line parallel and close to the fishing pole shaft and providing fishing line guidance at the intermediate line guide position;
means for providing vertical structure for small line guide hole, permanently connected to said means for keeping the fishing line parallel and close to the fishing pole shaft and providing fishing line guidance at the small line guide position;
means for providing line positioning control at the small line guide position, permanently connected to said means for keeping the fishing line parallel and close to the fishing pole shaft and providing fishing line guidance at the small line guide position; and
means for providing dependable secure easy mounting and removal for the small line guide component, permanently connected to said means for keeping the fishing line parallel and close to the fishing pole shaft and providing fishing line guidance at the small line guide position.

2. The fishing pole line management system in accordance with claim 1, wherein said means for line holding, line adjusting, line securing, hook securing comprises a flexible, ridged, light weight, clamping, snapping, slip on, line storage vertical member, line secure slots, hook secure slots line holder.

3. The fishing pole line management system in accordance with claim 1, wherein said means for keeping the fishing line parallel and close to the fishing pole shaft and providing fishing line guidance at the large line guide position comprises a flexible, ridged, light weight, line guiding, clamping, snapping, slip on large line guide.

4. The fishing pole line management system in accordance with claim 1, wherein said means for keeping the fishing line parallel and close to the fishing pole shaft and providing fishing line guidance at the intermediate line guide position comprises a flexible, ridged, light weight, line guiding, clamping, snapping, slip on intermediate line guide.

5. The fishing pole line management system in accordance with claim 1, wherein said means for keeping the fishing line parallel and close to the fishing pole shaft and providing fishing line guidance at the small line guide position comprises a flexible, ridged, light weight, line guiding, clamping, snapping, slip on small line guide.

6. The fishing pole line management system in accordance with claim 1, wherein said means for securing hook and line while fishing and not fishing comprises a slot feature hook/line securing slot.

7. The fishing pole line management system in accordance with claim 1, wherein said means for positioning line and holding line in a secure fashion comprises a ridged construction, vertical wall line holder vertical member.

8. The fishing pole line management system in accordance with claim 1, wherein said means for keeping fishing line in place at the front of the line holder comprises a ridged construction, angled surface line holder front line stop.

9. The fishing pole line management system in accordance with claim 1, wherein said means for keeping fishing line in place at the back of the line holder comprises a ridged construction, angled surface line holder back line stop.

10. The fishing pole line management system in accordance with claim 1, wherein said means for providing dependable secure easy mounting and removal for the line holder component comprises a flexible, ridged, strong clamping, easy to use, clamping, snapping, slip on line holder clamping cylinder.

11. The fishing pole line management system in accordance with claim 1, wherein said means for providing vertical structure for large line guide hole comprises a ridged design large line guide hole vertical tab.

12. The fishing pole line management system in accordance with claim 1, wherein said means for providing line positioning control at the large line guide position comprises a line guidance, easy line threading large line guide line hole.

13. The fishing pole line management system in accordance with claim 1, wherein said means for providing dependable secure easy mounting and removal for the large line guide component comprises a flexible, ridged, strong clamping, easy to use, clamping, snapping, slip on large line guide clamping cylinder.

14. The fishing pole line management system in accordance with claim 1, wherein said means for providing vertical structure for intermediate line guide hole comprises a ridged design intermediate line guide hole vertical tab.

15. The fishing pole line management system in accordance with claim 1, wherein said means for providing line positioning control at the intermediate line guide position comprises a line guidance, easy line threading intermediate line guide line hole.

16. The fishing pole line management system in accordance with claim 1, wherein said means for providing dependable secure easy mounting and removal for the intermediate line guide component comprises a flexible, ridged, strong clamping, easy to use, clamping, snapping, slip on intermediate line guide clamping cylinder.

17. The fishing pole line management system in accordance with claim 1, wherein said means for providing vertical structure for small line guide hole comprises a ridged design small line guide hole vertical tab.

18. The fishing pole line management system in accordance with claim 1, wherein said means for providing line positioning control at the small line guide position comprises a line guidance, easy line threading small line guide line hole.

19. The fishing pole line management system in accordance with claim 1, wherein said means for providing dependable secure easy mounting and removal for the small line guide component comprises a flexible, ridged, strong clamping, easy to use, clamping, snapping, slip on small line guide clamping cylinder.

20. A fishing pole line management system for holding, securing and adjusting fishing pole line length, comprising:
a flexible, ridged, light weight, clamping, snapping, slip on, line storage vertical member, line secure slots, hook secure slots line holder, for line holding, line adjusting, line securing, hook securing;
a flexible, ridged, light weight, line guiding, clamping, snapping, slip on large line guide, for keeping the fishing line parallel and close to the fishing pole shaft and providing fishing line guidance at the large line guide position;
a flexible, ridged, light weight, line guiding, clamping, snapping, slip on intermediate line guide, for keeping the fishing line parallel and close to the fishing pole shaft and providing fishing line guidance at the intermediate line guide position;
a flexible, ridged, light weight, line guiding, clamping, snapping, slip on small line guide, for keeping the fishing line parallel and close to the fishing pole shaft and providing fishing line guidance at the small line guide position;
a slot feature hook/line securing slot, for securing hook and line while fishing and not fishing;
a ridged construction, vertical wall line holder vertical member, for positioning line and holding line in a secure fashion, permanently connected to said line holder;
a ridged construction, angled surface line holder front line stop, for keeping fishing line in place at the front of the line holder, permanently connected to said line holder;
a ridged construction, angled surface line holder back line stop, for keeping fishing line in place at the back of the line holder, permanently connected to said line holder;
a flexible, ridged, strong clamping, easy to use, clamping, snapping, slip on line holder clamping cylinder, for providing dependable secure easy mounting and removal for the line holder component, permanently connected to said line holder;
a ridged design large line guide hole vertical tab, for providing vertical structure for large line guide hole, permanently connected to said large line guide;
a line guidance, easy line threading large line guide line hole, for providing line positioning control at the large line guide position, permanently connected to said large line guide;
a flexible, ridged, strong clamping, easy to use, clamping, snapping, slip on large line guide clamping cylinder, for providing dependable secure easy mounting and removal for the large line guide component, permanently connected to said large line guide;
a ridged design intermediate line guide hole vertical tab, for providing vertical structure for intermediate line guide hole, permanently connected to said intermediate line guide;
a line guidance, easy line threading intermediate line guide line hole, for providing line positioning control at the intermediate line guide position, permanently connected to said intermediate line guide;
a flexible, ridged, strong clamping, easy to use, clamping, snapping, slip on intermediate line guide clamping cylinder, for providing dependable secure easy mounting and removal for the intermediate line guide component, permanently connected to said intermediate line guide;
a ridged design small line guide hole vertical tab, for providing vertical structure for small line guide hole, permanently connected to said small line guide;
a line guidance, easy line threading small line guide line hole, for providing line positioning control at the small line guide position, permanently connected to said small line guide; and
a flexible, ridged, strong clamping, easy to use, clamping, snapping, slip on small line guide clamping cylinder, for providing dependable secure easy mounting and removal for the small line guide component, permanently connected to said small line guide.

21. The fishing pole line management system as recited in claim 20, further comprising:
a collapsible fishing pole, for preferred embodiment, adjustably positioned to said line holder, adjustably positioned to said large line guide, adjustably positioned to said intermediate line guide, and adjustably positioned to said small line guide.

22. The fishing pole line management system as recited in claim 20, further comprising:
a water resistant, durable, sticky adhesive shaft sizing shim material, for sizing diameter of alternative embodiment fishing pole.

23. The fishing pole line management system as recited in claim 20, further comprising:
an alternative embodiment fishing pole, for applications using shaft sizing shim material or other secured mounting method for the line holder, large line guide, intermediate line guide and small line guide, securely connected to said line holder, securely connected to said large line guide, securely connected to said intermediate line guide, and securely connected to said small line guide.

24. The fishing pole line management system as recited in claim 21, further comprising:
a water resistant, durable, sticky adhesive shaft sizing shim material, for sizing diameter of alternative embodiment fishing pole.

25. The fishing pole line management system as recited in claim 21, further comprising:
an alternative embodiment fishing pole, for applications using shaft sizing shim material or other secured mounting method for the line holder, large line guide, intermediate line guide and small line guide, securely connected to said line holder, securely connected to said large line guide, securely connected to said intermediate line guide, and securely connected to said small line guide.

26. The fishing pole line management system as recited in claim 22, further comprising:
an alternative embodiment fishing pole, for applications using shaft sizing shim material or other secured mounting method for the line holder, large line guide, intermediate line guide and small line guide, securely connected to said line holder, securely connected to said large line guide, securely connected to said intermediate line guide, and securely connected to said small line guide.

27. The fishing pole line management system as recited in claim 24, further comprising:
an alternative embodiment fishing pole, for applications using shaft sizing shim material or other secured mounting method for the line holder, large line guide, intermediate line guide and small line guide, securely connected to said line holder, securely connected to said large line guide, securely connected to said intermediate line guide, and securely connected to said small line guide.

28. A fishing pole line management system for holding, securing and adjusting fishing pole line length, comprising:
a collapsible fishing pole, for preferred embodiment;
a flexible, ridged, light weight, clamping, snapping, slip on, line storage vertical member, line secure slots, hook secure slots line holder, for line holding, line adjusting, line securing, hook securing, adjustably positioned to said fishing pole;
a flexible, ridged, light weight, line guiding, clamping, snapping, slip on large line guide, for keeping the fishing line parallel and close to the fishing pole shaft and providing fishing line guidance at the large line guide position, adjustably positioned to said fishing pole;
a flexible, ridged, light weight, line guiding, clamping, snapping, slip on intermediate line guide, for keeping the fishing line parallel and close to the fishing pole shaft and providing fishing line guidance at the intermediate line guide position, adjustably positioned to said fishing pole;
a flexible, ridged, light weight, line guiding, clamping, snapping, slip on small line guide, for keeping the fishing line parallel and close to the fishing pole shaft and providing fishing line guidance at the small line guide position, adjustably positioned to said fishing pole;
a slot feature hook/line securing slot, for securing hook and line while fishing and not fishing;
a ridged construction, vertical wall line holder vertical member, for positioning line and holding line in a secure fashion, permanently connected to said line holder;
a ridged construction, angled surface line holder front line stop, for keeping fishing line in place at the front of the line holder, permanently connected to said line holder;
a ridged construction, angled surface line holder back line stop, for keeping fishing line in place at the back of the line holder, permanently connected to said line holder;
a flexible, ridged, strong clamping, easy to use, clamping, snapping, slip on line holder clamping cylinder, for providing dependable secure easy mounting and removal for the line holder component, permanently connected to said line holder;
a ridged design large line guide hole vertical tab, for providing vertical structure for large line guide hole, permanently connected to said large line guide;
a line guidance, easy line threading large line guide line hole, for providing line positioning control at the large line guide position, permanently connected to said large line guide;
a flexible, ridged, strong clamping, easy to use, clamping, snapping, slip on large line guide clamping cylinder, for providing dependable secure easy mounting and removal for the large line guide component, permanently connected to said large line guide;
a ridged design intermediate line guide hole vertical tab, for providing vertical structure for intermediate line guide hole, permanently connected to said intermediate line guide;
a line guidance, easy line threading intermediate line guide line hole, for providing line positioning control at the intermediate line guide position, permanently connected to said intermediate line guide;
a flexible, ridged, strong clamping, easy to use, clamping, snapping, slip on intermediate line guide clamping cylinder, for providing dependable secure easy mounting and removal for the intermediate line guide component, permanently connected to said intermediate line guide;
a ridged design small line guide hole vertical tab, for providing vertical structure for small line guide hole, permanently connected to said small line guide;
a line guidance, easy line threading small line guide line hole, for providing line positioning control at the small line guide position, permanently connected to said small line guide;
a flexible, ridged, strong clamping, easy to use, clamping, snapping, slip on small line guide clamping cylinder, for providing dependable secure easy mounting and removal for the small line guide component, permanently connected to said small line guide;
a water resistant, durable, sticky adhesive shaft sizing shim material, for sizing diameter of alternative embodiment fishing pole; and
an alternative embodiment fishing pole, for applications using shaft sizing shim material or other secured mounting method for the line holder, large line guide, intermediate line guide and small line guide, securely connected to said small line guide, securely connected to said intermediate line guide, securely connected to said large line guide, and securely connected to said line holder.
